(19) United States
(12) Patent Application Publication
(10) Pub. No.: US 2017/0172349 A1
(43) Pub. Date: Jun. 22, 2017

(54) Single Use, Pliable, Foldable Gravy or Sauce Separator Container

(71) Applicants: Holly Freyre, Miami, FL (US); Carlos V. Freyre, Miami, FL (US); Murat Kuru, Miami, FL (US)

(72) Inventors: Holly Freyre, Miami, FL (US); Carlos V. Freyre, Miami, FL (US); Murat Kuru, Miami, FL (US)

(73) Assignee: Wine Solutions, LLC, Miami, FL (US)

(21) Appl. No.: 14/972,606

(22) Filed: Dec. 17, 2015

(51) Int. Cl. A47J 43/28; B01D 17/02

(52) U.S. Cl. CPC A47J 43/284; B01D 17/0208

(57) ABSTRACT

A simple, single use device for separating immiscible liquids comprising of a one piece integrated container constructed of transparent rigid film formed or molded of plastic that allows the container to remain upright, having an opening at the upper end through which the liquids are supplied into the container; two symmetric openings on each side in the upper end that act like handles allowing for easy transport of the device; a locking mechanism below the handles to seal the upper-end opening; a filter at the upper-end of the container to capture undesirable food particles; a mechanism by which to shape the opening of container and provide structural support to mitigate tipping; a printed measurement scale on the outside of one side of the container to measure the levels of liquids therein and on the opposite side the instructions for use; an annular opening at the bottom of the container that is a spout, nipple and the conduit for the outflow of desirable liquids; and a pincer mechanism on the undersurface of the container that is joined to the conduit spout and regulates the passage of liquid through the conduit and kept in place by means of a pouch.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISK APPENDIX

N/A

### BACKGROUND OF INVENTION

Field of Invention

This invention deals with a device that separates fluids/liquids, which are created when cooking fowl, such as turkey, chicken, duck, and meat such as beef, pork and many other foods into desirable (gravy) and undesirable (fat) components using the liquids' specific gravity differentials. Fat, having a different specific gravity from the other liquids formed through the cooking process, rises to the top of the liquids when the liquid is placed into a container and allowed to settle.

Discussion of Prior Art

In the art, there are many well-known devices that separate immiscible liquids. For example, Radna, U.S. Pat. No. 4,934,420 separate immiscible fluids by using an apparatus consisting of two metal container sections, one sitting above the other. A separatory funnel like container sits on top of an associated holding container connected by a conduit through which the liquid flows down and whose flow is controlled by a stopcock. However, this is an apparatus consisting of several parts that will not separate the desirable and non-desirable liquids and food particles within a single container, allow for the removal of said desirable fluids from said container and then dispose of the device with the non-desirable liquids and food particles with no further effort.

U.S. Pat. Nos. 3,713,778 and 3,836,334 both to Karamian, also disclose glass separatory funnels and conduits, controlled by stopcock, through which when the stopcock is open allows the lower layer to be drained. Air is allowed to seep into the glass funnel through a stopper closer at the upper end of the funnel, similar to U.S. Pat. No. 3,656,912 issued to Sugawara. However, unlike Radna, Karamian does not have an associated container to capture the drained fluid. It is a delicate apparatus made from glass, able to neither stand upright without support nor be disposed of with non-desirable liquids and food particles.

U.S. Pat. No. 3,257,170 to Marcus, et al, discloses a glass liquid separator apparatus similar to the Karamian design except that the air that flows back into the apparatus is fed through a tube that is connected to the stopcock at the bottom of the apparatus and back up into the glass funnel. Therefore, the air from the atmosphere will flow inside the funnel from the bottom to the top and replace the fluid flowing from the vessel. Similar to Karamian, this device does not have an associated container to capture the drained fluid. It is a delicate apparatus made from glass, able to neither stand upright without support nor be disposed of with non-desirable liquids and food particles.

U.S. Pat. No. 697,613 to Ellis discloses a multi-section cream separator that uses water and ice. It consists of a cone shaped metal funnel used at the lower end of the container; a holder is provided at the lower portion of the cone shaped partition to hold the ice; a conduit extends from the upper section of the container to lower portion of the cone shaped partition for supplying water; and, a discharge pipe connected to the lower portion of the cone-shaped partition which includes an exterior cock or faucet. When the water is supplied it is chilled by the ice and mixes with the milk to separate the cream. The lower level liquids can then be discharged by the pipe. However, this is a large separator system unsuitable for use in a kitchen environment.

U.S. Pat. No. 2,093,575 to Roberts discloses a visible measuring device for gasoline dispensing and separation of sediment. U.S. Pat. No. 802,997 to Laenger discloses a cistern that operates similar to the Robert's patent, and additionally includes a filter through which the liquid passes before entering container. U.S. Pat. No. 241,033 to Lewis; U.S. Pat. No. 2,419,666 to Werth; and U.S. Pat. No. 2,799,437 to Jepson disclose different construction of separating devices. Again, neither of these devices can be used effectively in a kitchen environment and are not single use, disposable with the non-desirable liquids and food particles.

All of these devices are useful in some way for separating two immiscible liquids. However, except for the Radna device, U.S. Pat. No. 4,934,420, all would be difficult and inefficient to use in an ordinary kitchen environment.

### Advantages

It is an objective of the present invention to provide a gravy separating device that overcomes the aforementioned problems with the prior art.

It is another objective of the present invention to provide a very light weight gravy separating device made of structured plastic film or thin molded plastic.

It is another objective of the present invention to provide an easy to use gravy separating device that is of one piece and self-contained.

It is another objective of the present invention to provide a self-standing gravy separator that can be viewed for accurately controlling the separating process.

It is another objective of the invention to filter non-desirable food particles that are suspended in fluid as said fluid is poured into container.

It is another objective of the present invention to allow the quick and clean disposal of the non-desirable fluids and food particles after removing desirable liquids.

It is another objective of the present invention to create a single use separator that is less expensive and more efficient than any other household centric immiscible liquids separator.

It is another objective of the present invention to allow for the device to require minimal space to store due to the flexible material composition which allows for the device to be folded and stored almost anywhere.

Thus, the embodiments provide for a separator that is lighter, more efficient, less expensive and more attractive than prior art immiscible liquid separator devices. These and other benefits of one or more aspects will become apparent from the consideration and accompanying drawings.

### BRIEF SUMMARY OF INVENTION

In accordance with an embodiment of the present invention, a device for separating immiscible liquids of different specific gravities, comprising of a container shape than can be elliptical, oval, rectangular, square, tapered or not to the shape of a funnel; consisting of a transparent thin film, molded or formed plastic and able to withstand high temperatures and stand upright; open on the upper end for supplying the liquids, and closed at bottom end where desirable liquids are dispensed after separation through a conduit spout, nipple, mammiliated spout found underneath the bottom; attached to or incorporated into the spout is a pincer to regulate the outflow of the liquid; the funnel bag contains two symmetric openings on each side in the upper end that act like handles allowing for easy transport of the device; below the handles on the inner walls of the bag is a pressure sensitive closure, zip-lock, threaded string; below the pressure sensitive closure is a mesh filter; the transparency of the material and measurement markings on one side of the bag provides for accurate volume reading and on the other side the instructions for use.

### BRIEF DESCRIPTION OF THE DRAWINGS

FIG. 1 is a perspective view of the liquid separating device according to the present invention.

FIG. 2 is a cross-sectional view of the liquid separating device according to the present invention excluding the pincer.

FIG. 3 is an isometric view of the bottom portion of the liquid separating device taken along horizontal plane passing through line 2-2 of FIG. 1 thereof.

FIG. 4 is a frontal view of the container showing the liquid separation and measurement scale.

### DRAWING—LIST OF REFERENCE NUMERALS

| | |
|---|---|
| 100 - liquid separator | 102 - bag |
| 103 - top-end opening | 104, 104a - handles |
| 106, 106a - closure | 107 - filter |
| 108 - measurement scale | 109 - instructions for use |
| 110 - bottom | 112 - spout, mammiliated spout, nipple |
| 114 - pincer mechanism | 116 - bottom panel |
| 118 - pouch | 120 - fat |
| 122 - gravy | 124 - interface |
| 126 - annular opening | 128, 128a - ribbon locking mechanism |

### DETAILED DESCRIPTION OF INVENTION

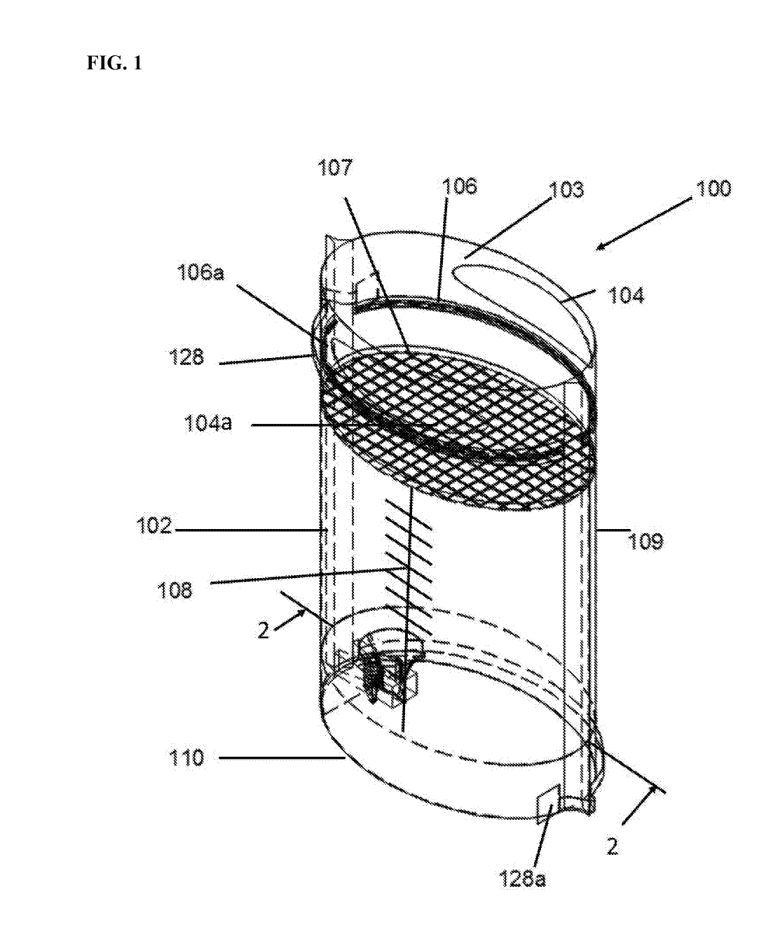

FIG. 1 shows a perspective view of one embodiment of self-standing liquid separator device 100 and includes a bag or pouch container 102 having an open upper end 103. In the preferred embodiment, the bag 102 is elliptically shaped, with similar or varying widths at the top end 103 and bottom 110 and transparent. The upper end 103 contains handles 104, 104a for carrying the device. Below each handle 104, 104a, on the inside walls of the bag 102 and parallel to each other is a closure mechanism, zip lock, string 106, 106a that closes the upper end of the bag 102. Below the closure mechanism 106, 106a, there is a filter 107, that is attached, embedded to the inside wall of the bag 102. In one embodiment, there are two ribbon like cinctures 128, 128a. The ribbon 128 is found towards the top and ribbon 128a is found at the bottom. One end of said ribbons is permanently affixed to the bag 102. The end of the ribbons not attached to said bag contain an adhesive substance, mechanical fastener on the side of said ribbon facing the bag 102, which allow the ribbons 128, 128a, to adhere, attach to the bag 102 when they come into contact. When ribbon 128 is pulled away from the connected end and parallel to the bag 102 and is adhered, attached to the outer surface of the bag, the upper end 103 of said bag will be formed into an oval or round shape, facilitating the opening for pouring the immiscible fluids into the bag. Concurrently, this act provides support to the structure of the bag 102 causing it to hold said shape and stiffen. When ribbon 128a is pulled away from the connected end and parallel to the bag and adhered to the outer surface of said bag it also shapes the bag into a round or oval form causing it to hold said shape and stiffen and support the structure of the bag 102. In another embodiment, the ribbon 128 can be arranged as a cross beam above the filter 107 to achieve the same shaping result. In another embodiment, assembled rods, plates or other structural shapes can be embedded, assembled to the top and bottom of the bag to create the desired shape. Adhering 128 and 128a in said manner mitigates said bag's tipping. Perpendicular to the top and bottom and on the outside and in the middle of the bag 102 is a measuring scale 108. On the other side panel is the labeling of the instructions for use 109.

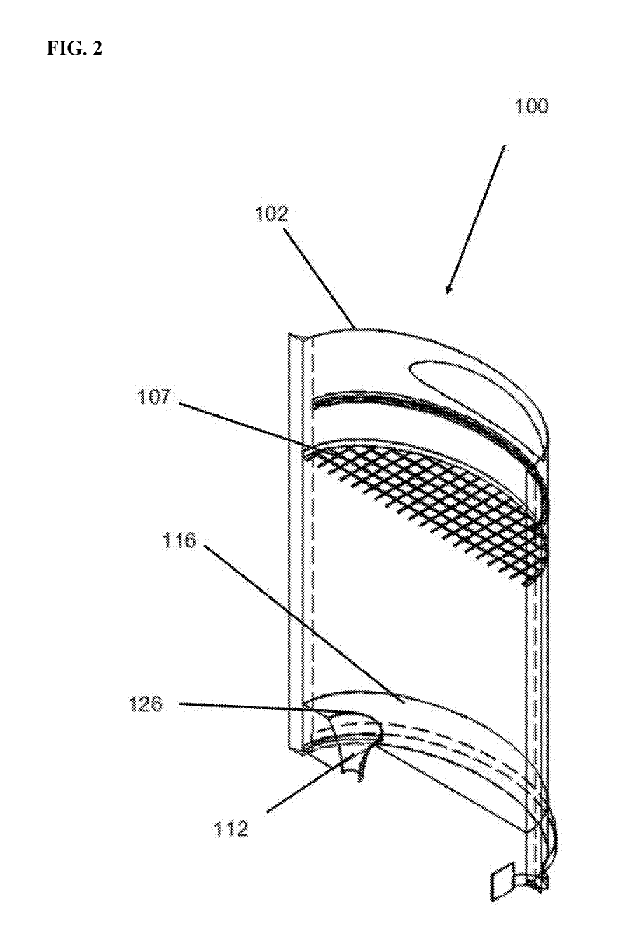

As shown in FIG. 2 cross section, the bottom panel 116 is parallel to the filter 107 and at one side there is an annular opening 126 and a spout, nipple 112 that is a conduit. The bottom panel 116 is attached to the bag 102 along its inside wall.

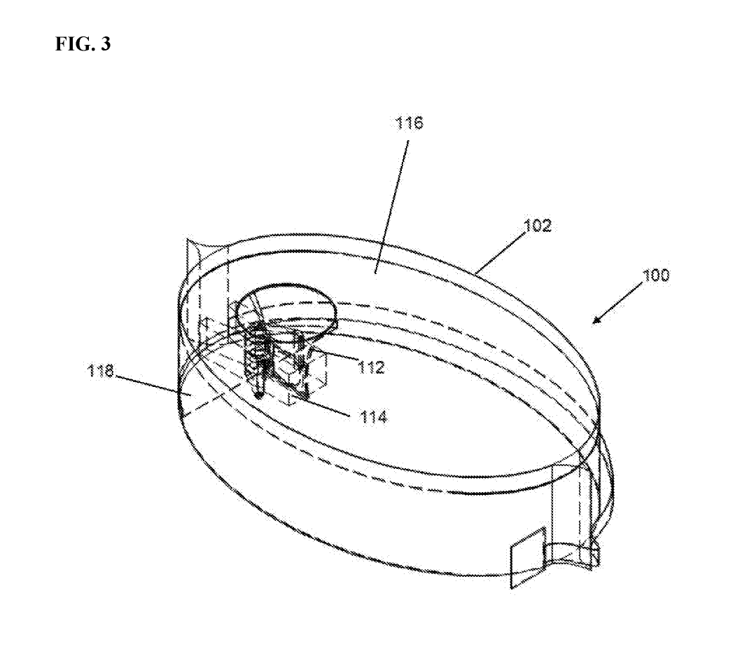

As shown in FIG. 3 an isometric view of the bottom section of the separator 100 taken along the line 2-2 as identified in FIG. 1, attached to one side of the inside wall of the bottom of the bag 102, there is a pouch, chamber 118. In the preferred embodiment, said pouch 118 holds said pincer mechanism 114 in place. Said pincer mechanism 114 is fitted into the pouch 118 and affixed to the spout 112. Depending on the operation of the pincer mechanism 114, liquid can travel through the conduit 112 and out the separator 100 or be blocked by the pincer mechanism 114. When in operation, the amount of force exerted on the pincer mechanism 114 will determine the flow rate of liquid out of the separator 100. In another embodiment the spout 112 is of mammiliated shape, acts as a bibb and when pinched opens allowing liquid to travel through conduit 112 and out separator 100. When released, it closes and locks the liquid from escaping.

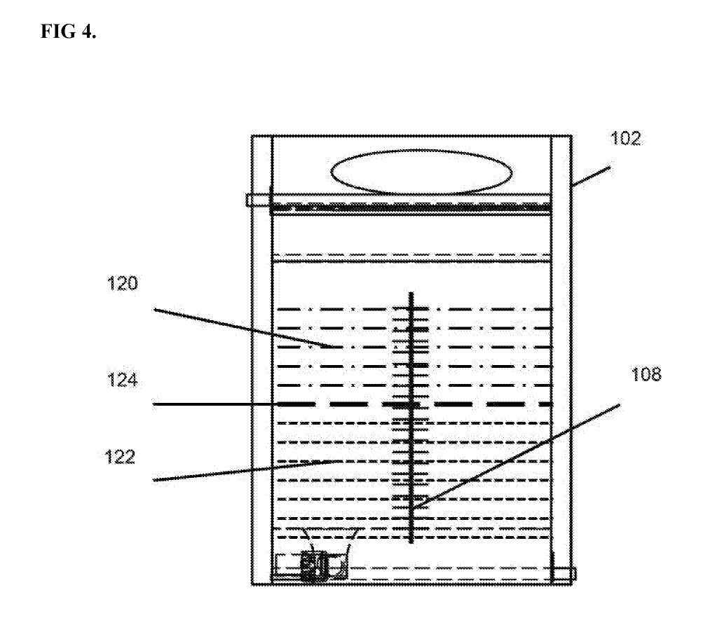

As shown in FIG. 4, the specific gravity differences of the liquids will cause the fat 120 to rise and interface 124 to form and the gravy 122 to sink. This can be seen through the transparent bag 102, and the amount of gravy contained in the bag measured against the measuring scale 108 on one side of the bag 102.

### Operation

Prior to pouring liquid into the separator 100, the user will read instructions 109 and ensure that the bag is in the upright position and that the pincer mechanism or mammiliated spout 114 is closed to prevent any liquid from passing through the spout 112. The bag top and bottom are shaped by means of external or internal structures like film ribbons, rods, embedded structural components or by incorporating additional components. The liquid produced from cooking fowl, for example a turkey, is poured through the top-end opening 103 and into the filter 107 to capture any undesirable food particles. As the liquid is poured through the opening 103, the filter 107 will prevent non-desirable food particles from passing through into the liquid. Once pouring is complete, the bag can be sealed by utilizing the closure 106, 106a or left open.

The upright bag, now filled with liquid can easily be moved to another location by grabbing its handles 104, 104a. Once moved, said bag should be left undisturbed to allow the fat 120 to separate from the gravy 122, as illustrated in the frontal view on FIG. 4. The specific gravity differences of the liquids will cause the fat 120 to rise and the gravy 122 to sink. This can be seen through the transparent bag 102, and the amount of gravy contained in the bag measured against the measuring scale 108 on one side of the bag 102.

To dispense the desired separated liquid (the gravy), lift said bag by the handles 104, 104a and with the other hand pinch the pincer mechanism, mammiliated spout 114 through the outside of the bag 102. Pinching the pincer will open the spout 112 and allow the gravy to flow out of the separator and into any available container. When the interface 124 between the fat 120 and gravy 122 comes close to the annular opening 126, the user releases the pincer mechanism, mammiliated spout 114, which automatically closes the conduit 112 and blocks any further fluid from flowing out. Thereupon the undesirable liquids and food particles can be disposed of with the separator, by sealing the top-end 103 with the locking mechanism 106, 106a and throwing away the separator 100. There is no need to spend any time and/or resources in cleaning the separator 100.

### CONCLUSION, RAMIFICATION AND SCOPE

The ease of use, simplicity of design and novelty of the present invention can be appreciated from the foregoing. This novel device for separating gravy is the only single use, single piece, self-standing gravy or sauce separator available for use in a typical kitchen environment.

Furthermore, the separator device has the additional benefits that it is:
Easy to handle, easy to use
Biodegradable
When not in use it is pliable and can be folded for easy storage anywhere
Less expensive than other separator devices
Provides the ability to close and dispose of undesirable components without the need to spend time or resources cleaning

Although the descriptions above contain much specificity, these should not be construed as limiting the scope of the embodiments but as merely providing illustrations of some of several embodiments. For example, the bag can have other shapes such as circular, square, oval, the pincer mechanism can have other shapes and the bag can be opaque on one side and transparent on the other, the pincer can be incorporated into the spout, and act as a bibb, the ribbons can be on the inside of the bag. Additional internal or external structures can be embedded or installed to keep the container in a certain desired shape.

Thus, the scope of the embodiments should be determined by appended claims and their legal equivalents, rather than by the examples given.

What is claimed is:

1. A single use immiscible liquid separator device, comprising:
a. a single piece integrated container constructed from transparent film and structured in such a way to allow said container to be self-standing;
b. a spout, nipple at the bottom of said container to allow the dispensing of liquids from said container;
c. a pincer mechanism joined to the undersurface of said container to control said spout to regulate the outflow of said liquids contained in said container;
d. a filter mesh that is part of said container structured to collect undesirable food particles when said liquids are introduced into said container;
whereby after said liquids separate due to their specific gravity differentials and said desirable liquid is removed, said container with said non-desirable liquids and food particles will be disposed of.

2. The device of claim 1, wherein said container further includes handles for grabbing and transporting said container.

3. The device of claim 1, wherein said container includes a closure mechanism to seal the top-end opening, means for to close upper end opening of said container.

4. The device of claim 1, where said container includes structural support components to shape the container.

5. The device of claim 1, wherein said structural support components are external to said container.

6. The device of claim 1, wherein said structural support components are internal to said container.

7. The device of claim 1, where said container includes vertical structures to provide support means for which to mitigate the tipping of said container.

8. The device of claim 1, wherein said container further includes a measurement scale on its outer surface to measure the volume of said liquids contained therein.

9. The device of claim 1, wherein said container further includes a hole at the bottom that serves as a spout through which said liquids flows out of said container.

10. The device of claim 1, wherein the said spout is controllably blocked by a pincer mechanism.

11. The device of claim 1, wherein the said spout is mammiliate shaped acting as a bibb to controllably block the flow of liquid.

12. The device of claim 1, wherein said container further is comprised of flexible material for folding and storing device flat.

13. The device of claim 1, wherein said filter is removable.

14. The device of claim 1, wherein the material is molded, formed plastic.

15. The device of claim 1, wherein the material is plastic coated paperboard.

16. A method of controllably separating liquids formed after cooking, comprising:
a. introducing immiscible liquids consisting of desirable and undesirable components into a disposable container with a spout and a pincer mechanism at the bottom;
b. filtering said liquids through a mesh filter;
c. employing gravitational force to act on the specific densities of said liquids;
d. achieving desired separation by the passage of time;
e. opening said pincer mechanism when said desired separation is achieved;
f. opening said nipple by squeezing;
g. dispensing of said desirable liquids through said spout;
h. disposing of said undesirable liquids inside said container;
whereby said immiscible liquids are controllably separated by means of employing the gravitational force on the specific densities of said liquids.

17. The method of claim 16 where separation is controlled by time.

18. The method of claim 16 where said separation progress is observed through the transparency of said container.

19. The method of claim 16 where said liquids form layers after separation.

20. The method of claim 16 where the dispensing is managed by controllably opening and closing the pincer mechanism.
